(19) United States
(12) Patent Application Publication
(10) Pub. No.: US 2021/0042168 A1
(43) Pub. Date: Feb. 11, 2021

(54) METHOD AND SYSTEM FOR FLEXIBLE PIPELINE GENERATION

(71) Applicant: Rubikloud Technologies Inc., Toronto, ON (CA)

(72) Inventors: Yuri BAKULIN, Toronto (CA); Marcio MARQUES, Toronto (CA)

(73) Assignee: Kinaxis Inc., Ottawa, ON, ON (CA)

(21) Appl. No.: 16/965,653

(22) PCT Filed: Jan. 28, 2019
(86) PCT No.: PCT/CA2019/050098

§ 371 Date: Jul. 29, 2020

Related U.S. Application Data
(60) Provisional application No. 62/623,242, filed on Jan. 29, 2018.

(51) Int. Cl. G06F 9/52; G06N 20/00

(52) U.S. Cl. CPC G06F 9/52; G06Q 10/06316; G06N 20/00

(57) ABSTRACT

A system and method for flexible pipeline generation. The method includes: generating two or more tasks, the two or more tasks define at least a portion of the pipeline; generating a reconfigurable workflow for defining associations for the two or more tasks, the workflow includes: mapping the output of at least one of the tasks with a culminating output; mapping the input of at least one of the tasks with the output of at least one of the other tasks; and mapping the input of at least one of the tasks with an originating input; and executing the pipeline using the workflow for order of execution of the two or more tasks.

### TECHNICAL FIELD

The following relates generally to data processing, and more specifically, to a method and system for flexible pipeline generation.

### BACKGROUND

Data science, and in particular, machine learning techniques can be used to solve a number of real world problems. Thus, even though these problems can vary greatly, the technical process to generate an outcome from one of the data science approaches can generally take the form of similar approaches, structures, or patterns. While in certain circumstances, different data science models or machine learning models may be different, there can be commonality in the overall structure.

When dealing with large data sets, it is often difficult to deal end to end in real time. In this case, different stages can be compiled into data processing pipelines. Whereby data processing pipelines generally mean giving a logical structure to how a system operates. However, conventional pipeline implementations can be rigid in their connections and structure, as well as having other undesirable aspects.

It is therefore an object of the present invention to provide a method and system in which the above disadvantages are obviated or mitigated and attainment of the desirable attributes is facilitated.

### SUMMARY

In an aspect, there is provided a method for flexible pipeline generation, the method executed on at least one processing unit, the method comprising: generating two or more tasks, the two or more tasks defining at least a portion of the pipeline; for each task, receiving a functionality for the respective task and receiving at least one input and at least one output associated with the respective task; generating a reconfigurable workflow for defining associations for the two or more tasks, the workflow having an originating input and a culminating output, the generating of the workflow comprising: mapping the output of at least one of the tasks with the culminating output; mapping the input of at least one of the tasks with the output of at least one of the other tasks; and mapping the input of at least one of the tasks with the originating input; and executing the pipeline using the workflow for order of execution of the two or more tasks.

In a particular case, the mapping of the input of at least one of the tasks with the output of at least one of the other tasks comprising, for each of task having an unmapped input, determining which outputs of other tasks are depended on to be received as input for the functionality of the respective task.

In another case, the mapping of the input of at least one of the tasks with the output of at least one of the other tasks comprising, for each of task having an unmapped output, determining which inputs of other tasks are depended on to be provided as output for the functionality of such other task.

In yet another case, the mapping of the input of at least one of the tasks with the output of at least one of the other tasks comprising: mapping the output of at least one of the tasks with the input of the at least one tasks mapped to the culminating output where such input is depended on for the functionality of the respective task; and iteratively determining whether inputs of any tasks having mapped outputs depend on an output of another task for the functionality of such task, and where there is such a dependency, mapping the input of the respective task to the output of the task to which the respective task depends, otherwise for the at least one tasks with an unmapped input, performing the mapping of the input of the at least one tasks with the originating input.

In yet another case, the mapping of the input of at least one of the tasks with the output of at least one of the other tasks comprising: mapping the input of at least one of the tasks with the output of the at least one tasks mapped to the originating input where such output is depended on for the functionality of the respective task; and iteratively determining whether outputs of any tasks having mapped inputs depend on an input of another task for the functionality of such task, and where there is such a dependency, mapping the output of the respective task to the input of the task to which the respective task depends, otherwise for the at least one tasks with an unmapped output, performing the mapping of the output of the at least one tasks with the culminating output.

In yet another case, the mapping of the output of at least one of the tasks with the culminating output comprising determining whether outputs of at least one of the tasks are not depended on as input to at least one of the other tasks and mapping the outputs of such tasks to the culminating output.

In yet another case, the mapping of the input of at least one of the tasks with the originating input comprising determining whether inputs of at least one of the tasks are not depended on as output to at least one of the other tasks and mapping the inputs of such tasks to the originating input.

In yet another case, the mapping of the output of at least one of the tasks with the culminating output comprising mapping the output of the at least one of the tasks that comprise an output signifier to the culminating output.

In yet another case, the mapping of the input of at least one of the tasks with the originating input comprising mapping the input of the at least one of the tasks that comprise an input signifier to the originating input.

In yet another case, the method further comprising: receiving modification, the modification comprising at least one of: a modified functionality for at least one of the tasks, a modified input for at least one of the tasks, a modified output for at least one of the tasks, a removal of at least one of the tasks, and an addition of a new task comprising a functionality, an input, and an output; reconfiguring the workflow by redefining associations for the tasks with the modification, reconfiguring the workflow comprising: mapping the output of at least one of the tasks with the culminating output; mapping the input of at least one of the tasks with the output of at least one of the other tasks; and mapping the input of at least one of the tasks with the originating input; and executing the pipeline using the reconfigured workflow for order of execution of the tasks.

In another aspect, there is provided a system for flexible pipeline generation, the system comprising at least one processing unit and a data storage, the at least one processing unit in communication with the data storage and configured to execute: a task module to generate two or more tasks, the two or more tasks defining at least a portion of the pipeline, for each task, the task module receives a functionality for the respective task and receives at least one input and at least one output associated with the respective task; a workflow module to generate a reconfigurable workflow for defining associations for the two or more tasks, the workflow having an originating input and a culminating output, the generating of the workflow comprising: mapping the output of at least one of the tasks with the culminating output; mapping the input of at least one of the tasks with the output of at least one of the other tasks; and mapping the input of at least one of the tasks with the originating input; and an execution module to execute the pipeline using the workflow for order of execution of the two or more tasks.

In a particular case, the mapping of the input of at least one of the tasks with the output of at least one of the other tasks comprising, for each of task having an unmapped input, determining which outputs of other tasks are depended on to be received as input for the functionality of the respective task.

In another case, the mapping of the input of at least one of the tasks with the output of at least one of the other tasks comprising, for each of task having an unmapped output, determining which inputs of other tasks are depended on to be provided as output for the functionality of such other task.

In yet another case, the mapping of the input of at least one of the tasks with the output of at least one of the other tasks comprising: mapping the output of at least one of the tasks with the input of the at least one tasks mapped to the culminating output where such input is depended on for the functionality of the respective task; and iteratively determining whether inputs of any tasks having mapped outputs depend on an output of another task for the functionality of such task, and where there is such a dependency, mapping the input of the respective task to the output of the task to which the respective task depends, otherwise for the at least one tasks with an unmapped input, performing the mapping of the input of the at least one tasks with the originating input.

In yet another case, the mapping of the input of at least one of the tasks with the output of at least one of the other tasks comprising: mapping the input of at least one of the tasks with the output of the at least one tasks mapped to the originating input where such output is depended on for the functionality of the respective task; and iteratively determining whether outputs of any tasks having mapped inputs depend on an input of another task for the functionality of such task, and where there is such a dependency, mapping the output of the respective task to the input of the task to which the respective task depends, otherwise for the at least one tasks with an unmapped output, performing the mapping of the output of the at least one tasks with the culminating output.

In yet another case, the mapping of the output of at least one of the tasks with the culminating output comprising determining whether outputs of at least one of the tasks are not depended on as input to at least one of the other tasks and mapping the outputs of such tasks to the culminating output.

In yet another case, the mapping of the input of at least one of the tasks with the originating input comprising determining whether inputs of at least one of the tasks are not depended on as output to at least one of the other tasks and mapping the inputs of such tasks to the originating input.

In yet another case, the mapping of the output of at least one of the tasks with the culminating output comprising mapping the output of the at least one of the tasks that comprise an output signifier to the culminating output.

In yet another case, the mapping of the input of at least one of the tasks with the originating input comprising mapping the input of the at least one of the tasks that comprise an input signifier to the originating input.

In yet another case, the task module further receives modification, the modification comprising at least one of: a modified functionality for at least one of the tasks, a modified input for at least one of the tasks, a modified output for at least one of the tasks, a removal of at least one of the tasks, and an addition of a new task comprising a functionality, an input, and an output; the workflow module reconfigures the workflow by redefining associations for the tasks with the modification, reconfiguring the workflow comprising: mapping the output of at least one of the tasks with the culminating output; mapping the input of at least one of the tasks with the output of at least one of the other tasks; and mapping the input of at least one of the tasks with the originating input; and the execution module further executes the pipeline using the reconfigured workflow for order of execution of the tasks.

These and other embodiments are contemplated and described herein. It will be appreciated that the foregoing summary sets out representative aspects of systems and methods to assist skilled readers in understanding the following detailed description.

### BRIEF DESCRIPTION OF THE DRAWINGS

The features of the invention will become more apparent in the following detailed description in which reference is made to the appended drawings wherein:

FIG. 1 is a schematic diagram of a system for flexible pipeline generation, in accordance with an embodiment;

FIG. 2 is a schematic diagram showing the system of FIG. 1 and an exemplary operating environment;

FIG. 3 is a flow chart of a method for flexible pipeline generation, in accordance with an embodiment;

FIG. 4 is a diagram of an exemplary implementation of the system of FIG. 1;

FIG. 5 is a diagram of the exemplary implementation of FIG. 4 having a different configuration;

FIG. 6 is a diagrammatic example implementation of the system of FIG. 1; and

FIG. 7 illustrates a diagrammatic example of a pipeline.

### DETAILED DESCRIPTION

Embodiments will now be described with reference to the figures. For simplicity and clarity of illustration, where considered appropriate, reference numerals may be repeated among the Figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description.

Any module, unit, component, server, computer, terminal, engine or device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the device or accessible or connectable thereto. Further, unless the context clearly indicates otherwise, any processor or controller set out herein may be implemented as a singular processor or as a plurality of processors. The plurality of processors may be arrayed or distributed, and any processing function referred to herein may be carried out by one or by a plurality of processors, even though a single processor may be exemplified. Any method, application or module herein described may be implemented using computer readable/executable instructions that may be stored or otherwise held by such computer readable media and executed by the one or more processors.

In the following description, it is understood that the terms “user”, “developer”, and “administrator” can be used interchangeably.

The following relates generally to data processing, and more specifically, to a method and system for flexible pipeline generation.

As described herein, when dealing with large data sets, it is often difficult to deal end to end in real time. In this case, different stages can be compiled into data processing pipelines. Whereby data processing pipelines generally mean giving a structure to the operation of a system employing machine learning techniques.

For systems that employ machine learning, a typical pipeline can include various stages or components; for example: a data gathering stage for gathering raw data; a transformations stage for performing transformations of the raw data; a training stage to feed the transformed data into a machine learning model in order to train the model; an application stage to apply the trained model to actual test data; and an output stage to produce scores for various model parameters. In some cases, there may also be a manipulation stage to allow for user specific manipulation of the output data. Depending on the type of solution, some pipelines may vary, including having different stages and different branching between stages.

Typically, each of the independent components of the pipeline is executed in each single implementation of the pipeline. In the embodiments described herein, a batch data processing system is provided to implement each of the individual components and stitch them together in a way that is flexible, for example, to solve technical problems related to machine learning based systems.

In a particular case, batch data processing can be implemented via a pipeline; for example via a Python™ module called “Luigi”. Using such a module allows a system to break up a large, multi-step data processing task into a graph of smaller sub-tasks with particular interdependencies. Thus, allowing the system to build complex pipelines of batch jobs by handling dependency resolution, workflow management, visualization, handling failures, command line integration, among others. Luigi allows for the definition of specific components into a “task”. Luigi is modular and allows for the creation of dependencies between tasks. The system receives from a user a desired output, and the system, via Luigi, schedules the required tasks or jobs to be run in order to achieve the desired output.

When building a pipeline with, for example, Luigi, each task generally has to be defined. The definition of each task involves defining the function of each task and what is required to accomplish such function. Thus, the dependencies for each task, which other tasks it depends on, generally have to be hard-coded into its definition. As an example, the function of a ‘Task A’ can be defined, and that such function is dependent on another task, ‘Task B’, can be defined. In this example, a system employing Luigi will identify that at run time, Task A will only be run if Task B is already complete, due to the dependency of Task A on Task B. In this case, dependency is understood to mean that at least one of the inputs of Task A are dependent on there being a value on at least one of the outputs of Task B. As such, every time Task A is run, the system will query whether Task B is already complete, and thus, not run Task A until Task B is complete.

The hard-coded dependencies of Luigi, and similar modules, can mean that changing the pipeline, such as insertion of a new task or changing of dependencies, can be costly, time consuming, and inconvenient because it would require redefining of the affected tasks. As an example, if during training of a machine learning model, experimentation was desired with different types of inputted data, it would be exceedingly inefficient to have to change the code for one or more tasks for each experiment.

In the embodiments described herein, Applicant recognized the substantial advantages of decoupling functionality of a task from its dependencies in order to generate a flexible pipeline.

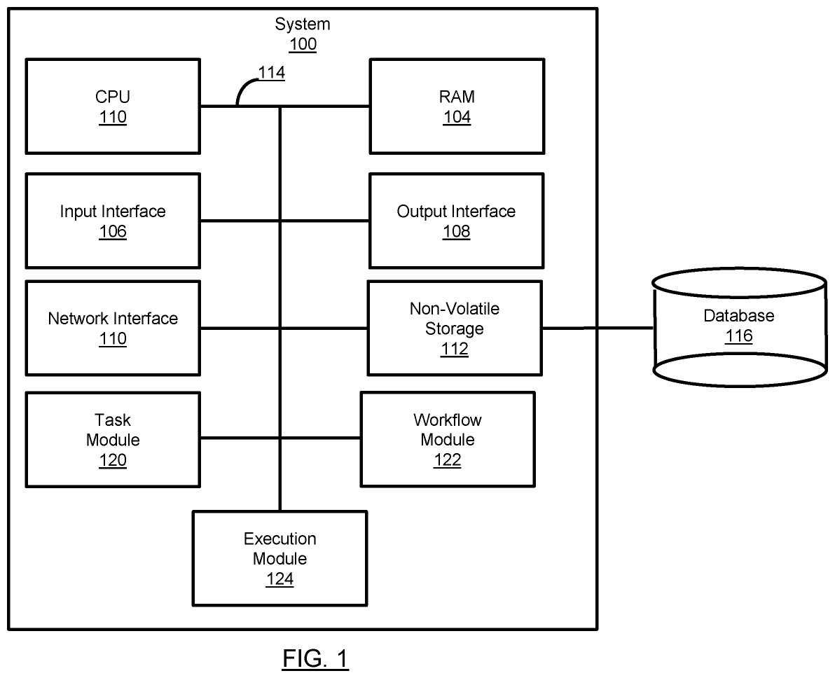

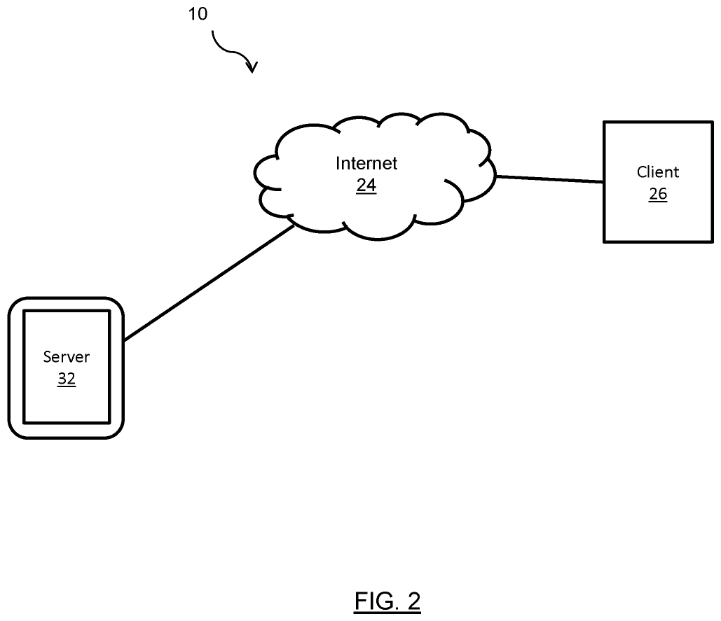

Referring now to FIG. 1, a system 100 for flexible pipeline generation, in accordance with an embodiment, is shown. In this embodiment, the system 100 is run on a client side device (26 in FIG. 2) and accesses content located on a server (32 in FIG. 2) over a network, such as the internet (24 in FIG. 2). In further embodiments, the system 100 can be run on any other computing device; for example, a desktop computer, a laptop computer, a smartphone, a tablet computer, a point-of-sale (“PoS”) device, a server, a smartwatch, distributed or cloud computing device(s), or the like.

In some embodiments, the components of the system 100 are stored by and executed on a single computer system. In other embodiments, the components of the system 100 are distributed among two or more computer systems that may be locally or remotely distributed.

FIG. 1 shows various physical and logical components of an embodiment of the system 100. As shown, the system 100 has a number of physical and logical components, including a central processing unit (“CPU”) 102 (comprising one or more processors), random access memory (“RAM”) 104, an input interface 106, an output interface 108, a network interface 110, non-volatile storage 112, and a local bus 114 enabling CPU 102 to communicate with the other components. CPU 102 executes an operating system, and various modules, as described below in greater detail. RAM 104 provides relatively responsive volatile storage to CPU 102. The input interface 106 enables an administrator or user to provide input via an input device, for example a keyboard and mouse. The output interface 108 outputs information to output devices, for example, a display and/or speakers. The network interface 110 permits communication with other systems, such as other computing devices and servers remotely located from the system 100, such as for a typical cloud-based access model. Non-volatile storage 112 stores the operating system and programs, including computer-executable instructions for implementing the operating system and modules, as well as any data used by these services. Additional stored data, as described below, can be stored in a database 116. During operation of the system 100, the operating system, the modules, and the related data may be retrieved from the non-volatile storage 112 and placed in RAM 104 to facilitate execution.

In an embodiment, the CPU 102 is configurable to execute a task module 120, a workflow module 122, and an execution module 124. As described herein, as part of the pipeline, the system 100 can use a machine learning model and/or statistical model incorporated into one or more tasks. The one or more models can include interpolation models (for example, Random Forest), extrapolation models (for example, Linear Regression), deep learning models (for example, Artificial Neural Network), ensembles of such models, and the like.

Tasks, as referred to herein, can comprise any executable sub-routine or operation; for example, a data gathering operation, a data transformation operation, a machine learning model training operation, a weighting operation, a scoring operation, an output manipulation operation, or the like.

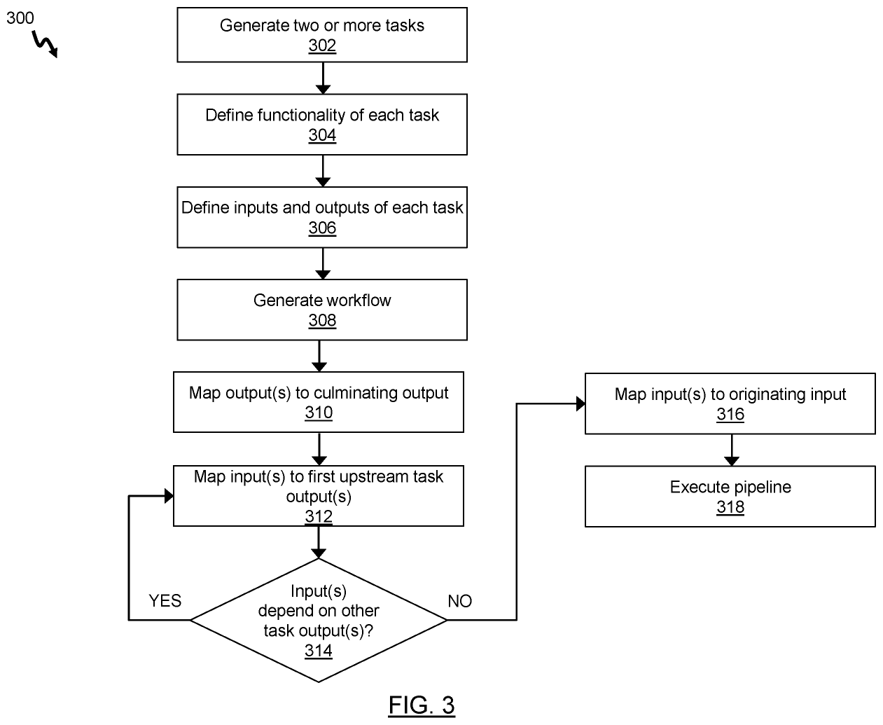

FIG. 3 illustrates a flowchart for a method 300 for flexible pipeline generation, according to an embodiment.

At block 302, the task module 120 generates two or more tasks that collectively comprise a pipeline. The two or more tasks form the building blocks of the pipeline. At block 304, for each task, the task module 120 performs a run command which defines the functionality of that respective task. At block 306, for each task, the task module 120 also defines at least one input and at least one output to realize the functionality of that respective task. In an embodiment, as described, the definition of the at least one input and the at least one output are defined by a user or a developer. As an example, defining a task can be implemented as follows:

class TaskA(system.Task):

```
@system_input
def transaction_data(self):
  . . .
@system_ouptut
  def order_count_model(self):
  . . .
```

In the above example, transaction_data function has an expected value of a structure (for example via a path to a comma-separated values (CSV) file) for retrieving alpha-numeric strings or integers to implement the function, as well as alpha-numeric strings or integers to provide to other functions (for example, an integer to provide to the order_count_model function). The order_count_model function can include a path to a picked model object that implements a ‘model.fit(feature_vector)’ method.

At block 308, the workflow module 122 generates a workflow framework for automatically defining logical components associated with the tasks. The workflow is a set of logical relationships between the tasks. In some cases, the workflow may be referred to as a “dependency tree”. In an embodiment, the workflow framework comprises a culminating output and an originating input.

At block 310, the workflow module 122 maps one or more task outputs to the culminating output by querying the inputs of the other tasks and determining data from which task outputs are not depended on as input to one of the other tasks. In an embodiment, the workflow module 122 can map one or more task outputs to the culminating output by querying for a predetermined output signifier defined within the definition of the respective task or defined with the output of the respective task. In a particular case, the output signifier can be defined by a user or a developer to signify what is desired to be mapped to the culminating output. The one or more tasks with an output mapped to the culminating output are referred to herein as “first upstream tasks”. At block 312, the workflow module 122 maps one or more task outputs to the input of the first upstream tasks; such one or more tasks referred to herein as “second upstream tasks”. The output of the second upstream tasks are mapped to the input of the first upstream tasks by determining data from which task outputs are depended on as inputs to the first upstream tasks in order for the first upstream tasks to function.

At block 314, the workflow module 122 determines whether any inputs of the second upstream tasks depend on data from an output of another task to function. If the determination at block 314 is positive, the workflow module 122 repeats block 312 by mapping one or more task outputs to the input of the second upstream tasks; such one or more tasks referred to herein as “third upstream tasks”. Such mapping of inputs of tasks at a current upstream level to outputs of successive upstream tasks (referred to as “‘n’ upstream tasks”) is repeated by the workflow module 122 until the determination at block 314 is negative.

At block 316, if the determination at block 314 is negative, the workflow module 122 maps the inputs of any tasks that are not mapped to an output of another task to the originating input. In an embodiment, the workflow module 122 can map one or more task inputs to the originating input by querying for a predetermined input signifier defined within the definition of the respective task or defined with the input of the respective task. In a particular case, the signifier can be defined by a user or a developer to signify what is desired to be mapped to the originating input.

At block 318, the execution module 124 executes tasks in the pipeline. The execution module 124 consults with the workflow, as generated by the workflow module 122, to determine an order by which to execute the tasks.

In an embodiment, the workflow module 122 determines which task outputs depend on which task inputs based on user or developer input provided via the input interface 106.

Advantageously, the system 100 allows for decoupling of dependencies from the definition of the task, as opposed to that which is required in Luigi, to provide flexibility as to the configuration, and ultimate functionality, of the pipeline. In this way, the workflow is re-definable, for example by the user or developer, as to the implementation of the pipeline. Further, advantageously, the above allows each of the individual tasks to be reusable. In this way, a user or developer does not need to change input and/or output definitions in any of the existing tasks. Nor is the user or developer required to make changes to an existing workflow. In some cases, as described herein, the system 100 can run the above approach again with the redefined tasks, such that the subclass of an existing workflow is defined that can override the relevant workflow components.

In further embodiments, the workflow module 122 can perform method 300 in reverse, by building the pipeline starting from the originating input and mapping the downstream tasks. For example, mapping tasks (referred to as “first downstream tasks”) with inputs that are not dependent on the outputs of any other tasks to the originating input. Then, mapping the outputs of the first downstream tasks to the inputs of other tasks (referred to as “second downstream tasks”) that depend on the output of the first downstream tasks, and so on. This mapping of outputs to the inputs of downstream tasks can be continued until the outputs of particular tasks are not depended on by any other tasks' inputs, whereby such outputs can be mapped to the culminating output.

For the purposes of the examples provided herein, prediction is understood to mean a process of obtaining an estimated future value for a subject using historical data. In most cases, predictions are predicated on there being a set of historical data from which to generate one or more predictions. In these cases, machine learning techniques can rely on a plethora of historical data in order to train their models and thus produce reasonably accurate forecasts.

In an example implementation of the embodiments described herein, the user can define the following:

class ConsumerTask(system.Task):

@system_input
def consumer_input(self):

pass

class ProducerTaskA(system.Task):

@system_output
def producer_output(self):

pass

class WorkflowA(system.Workflow):

@system_component
def producer_component(self):

return ProducerTaskA( )

@system_component
def consumer_component(self):

return ConsumerTask( )

def workflow(self):

self.consumer_component.consumer_input = \

self.producer_component.producer_output

The above is an example of the embodiments described herein for a minimal workflow that defines two logical components (producer_component, consumer_component) and maps the output of the former to the input of the latter. It also defines the implementation of those components to be ProducerTaskA and ConsumerTask respectively.

As the above is generated using the embodiments described herein, if the user wanted to construct a new workflow, for example, replacing ProducerTaskA with some other logic, the user just needs to write a new task. The new task merely requiring new logic, making sure that the new task's output matches the structure expected by the consumer component, and to override that component definition in a new workflow that extends/subclasses the original workflow. As an example:

class ProductTaskB(system.Task):

@system_output
def producer_output(self):

pass

class WorkflowB(system.Workflow):

@system_component
def producer_component(self):

return ProducerTaskB( )

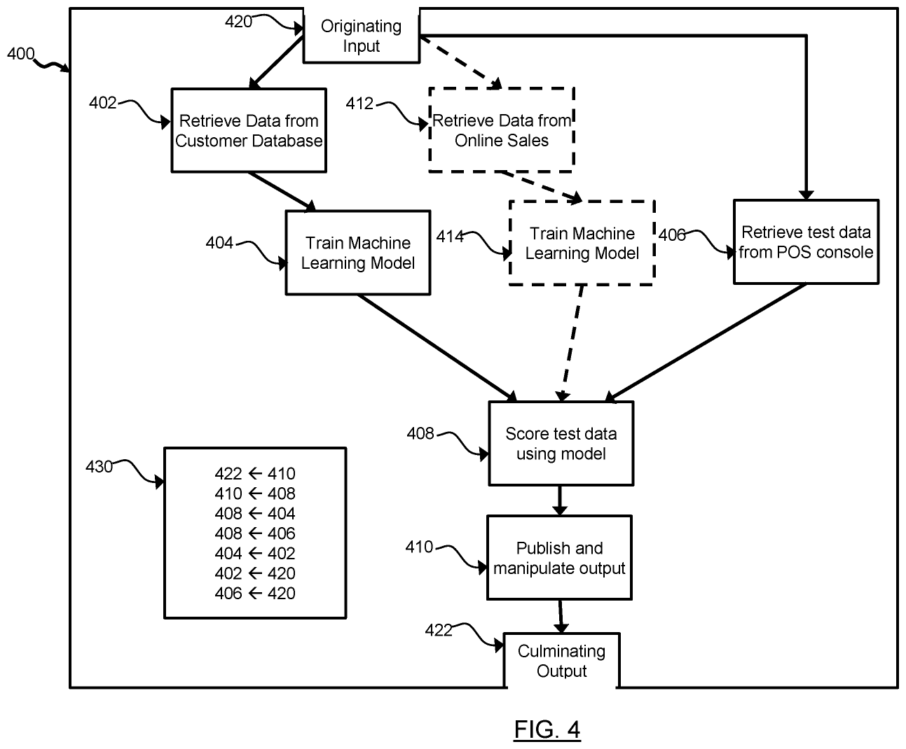

FIG. 4 illustrates another exemplary implementation of the embodiments described herein. In this example, a pipeline 400 is directed to using a machine learning model to predict the outcome of a promotion of a product; such as predicting the increase or decrease in sales of the product. The pipeline 400 includes an originating input 420, a culminating output 422, and five separate tasks generated by the task module 120. In a first case of the pipeline, the five tasks are: a first task 402 having the functionality of retrieving data from a database of previous purchases of the product; a second task 404 having the functionality of training a machine learning model with input data; a third task 406 having the functionality of retrieving test data from a point-of-service console; a fourth task 408 having the functionality of scoring the test data to arrive at a prediction; and a fifth task 410 having the functionality of publishing and manipulating the output (the prediction).

In this example, the pipeline 400 also includes a workflow 430 generated by the workflow module 122. In the first case, the workflow module 122 maps the fifth task 410 to the culminating output 422 by determining that there are no other tasks that have inputs that depend on the output of the fifth task 410. The workflow module 122 then maps the output of the fourth task 408 to the input of the fifth task 410 as the input of the input of the fifth task 410 depends on the output of the fourth task 408. The workflow module 122 then maps the output of the second task 404 and the output of the third task 406 to the input of the fourth task 408 as this input depends on data from the output of both tasks. The workflow module 122 then maps the output of the first task 402 to the output of the second task 404. The workflow module 122 then maps the inputs of the first task 402 and the third task 406 to the originating input 420 as the inputs of both those tasks are not dependent on the output of any other tasks. Consulting with the workflow 430 as generated by the workflow module 122, the execution module 124 can execute each off the tasks in the proper order. Thus, the system 100, following the generated pipeline 400, can retrieve customer data from a database and train a machine learning model using such data, the trained machine learning model being able to predict promotion outcomes using the customer data. Using the trained machine learning model, inputted test data (and test parameters) can be scored in order to arrive at a prediction for that particular inputted data. The scored data (prediction) can be published (for example, displayed on a screen via the output interface 108 or sent over the network interface 110 in JavaScript Object Notation (JSON) or comma-separated values (CSV) format) and, in some cases, manipulated by a user via the input interface 106. The output of which can form the culminating output 422 of the pipeline 400.

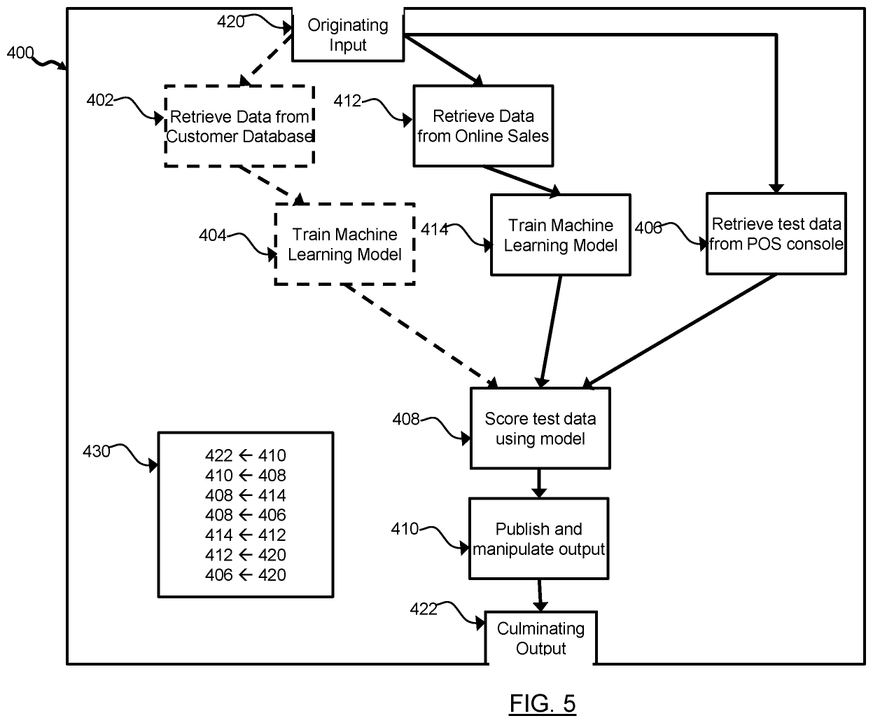

FIG. 5 illustrates an example adaptation of the exemplary implementation of FIG. 4. In this case, the user decided to experiment by retrieving a different dataset and using that data to train a different machine learning model. In this example, the task module 120 generates a sixth task 412 with a functionality of retrieving training data from an online sales database. The task module 120 also generates a seventh task 414 for training a new machine learning model with the online sales data. As such, the workflow module 122 regenerates the workflow 430 using the approach described above; however, in this case, the workflow module 122 maps the output of the seventh task 414 and the output of the third task 406 to the input of the fourth task 408. The workflow module 122 also maps the output of the fifth task 412 to the input of the sixth task 414, and then maps the input of the fifth task 412 to the originating input 420. Then, consulting again with the amended workflow 430 as generated by the workflow module 122, the execution module 124 can execute each off the tasks in the amended pipeline 400 in the proper order.

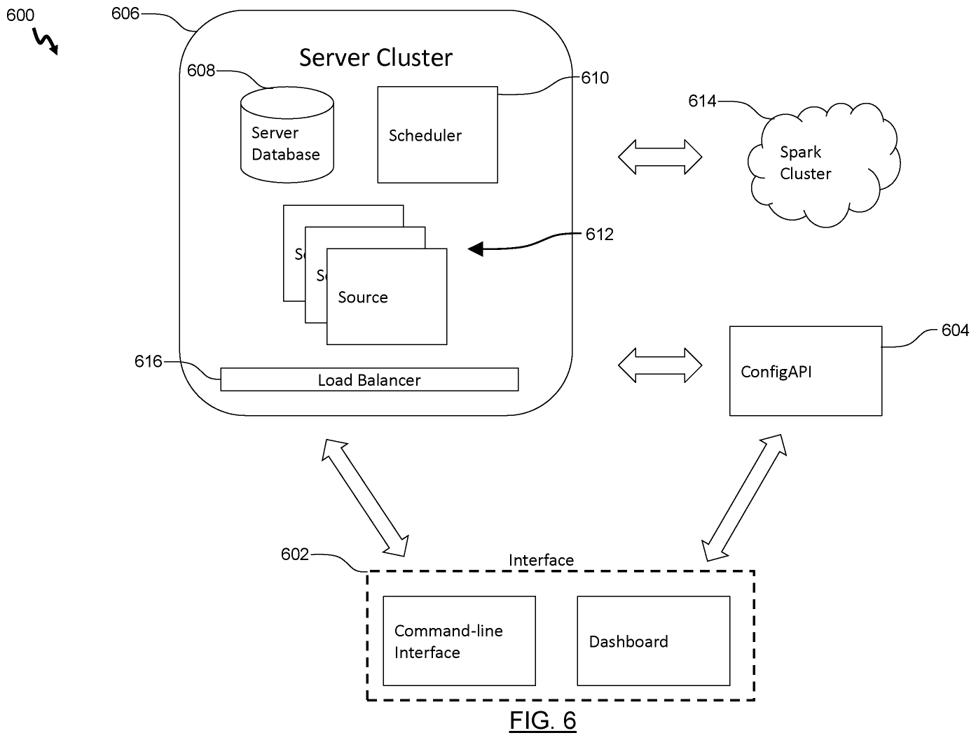

FIG. 6 illustrates a diagrammatic example implementation 600 of the system 100. In this example, there includes a user interface 602 for integrating with the workflow executing server and to allow for, for example, configuration, submission, and monitoring of workflows by the user. There also includes a configuration API 604 that is a service for centralized, modular management of job configurations. There also includes a spark cluster 614 for “pluggable” parallelizing and/or distributing processing. There also includes a server cluster 606 comprising one or more servers, each comprising one or more processors, a data storage memory, and a load balancer 616. In this way, the server cluster 606 can be a distributed execution environment for workflows. The server cluster 606 includes a database 608 for maintaining server state with respect to jobs, workers, or the like. The server cluster 606 also includes a scheduler 610 for synchronizing work among multiple workers, and for providing a monitoring interface for executing workflows. The server cluster 606 also includes a plurality of workers 612 (also called “sources”) for executing respective workflows. In this example implementation 600, advantageously, there can be intelligent load balancing due to having the ability to learn the resource requirements of a job or workflow from its parameters (and historical executions) and assign the job to a worker node in a way that optimizes resource usage, time, or cost. In this example implementation 600, also advantageously, there can be pluggability because each relevant component can interact with the system 100 through a well-defined interface. This allows easily switching the instance of the resource that is used. In the case of a spark cluster, for example, the same deployment of the system 100 can use a local instance of spark, a local cluster, or a managed cloud service, with no changes to its setup.

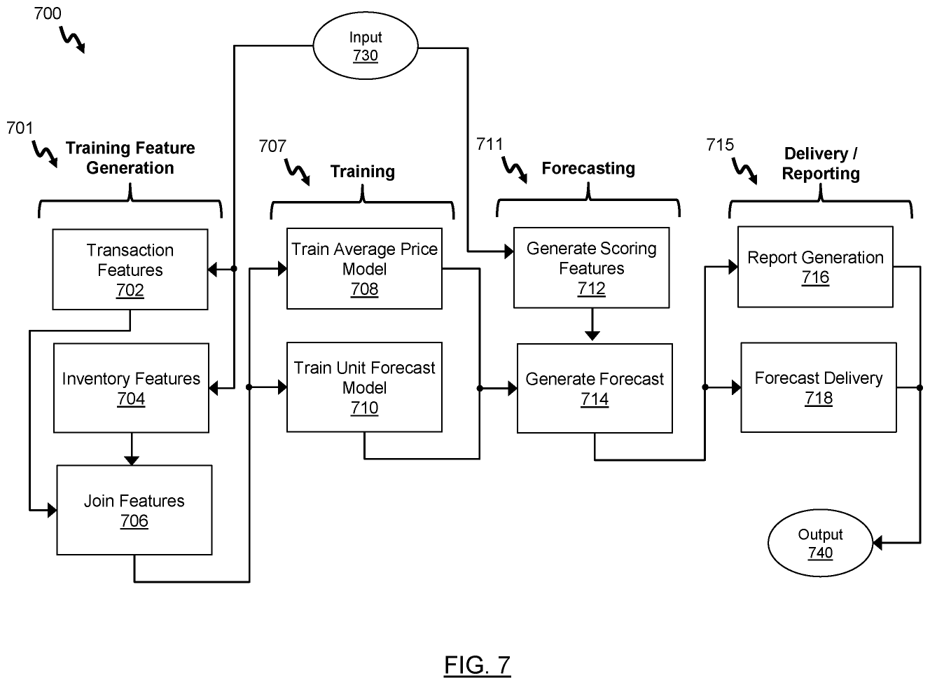

As illustrative of the embodiments described herein, FIG. 7 illustrates an exemplary pipeline and exemplary associated tasks that can be used in the embodiments described herein; in this case, for producing forecasts of sales of particular product(s) in an inventory based on transaction features (history). It is understood that the tasks described in this example can be generated and routed flexibly, as described with respect to the flexible pipeline generation described herein. It is understood that the tasks are not necessarily sequential, as there can be non-linearity in the dependencies.

In this example, the pipeline 700 first involves generating a training feature 701, which includes the tasks of transaction features 702, inventory features 704, and join features 706. In this example, the transaction features task 702 includes, as functions, extracting transaction data from a database, transforming and extracting specific features from the transaction data, and saving the transaction feature set, for example in a comma-separated values (CSV) file. The transaction features task 702 is mapped by the workflow module 122 to the originating input 730 where it receives the input CSV file. The transaction features task 702 further includes outputting a modified CSV file or a path to the modified CSV file.

In this example, the inventory features task 704 includes, as functions, extracting inventory data from the database, transforming and extracting specific features from the inventory data, and saving the inventory feature set, for example in a comma-separated values (CSV) file. The inventory features task 704 is mapped by the workflow module 122 to the originating input 730 where it receives the input CSV file. The inventory features task 704 further includes outputting a second modified CSV file or a path to the second modified CSV file.

In this example, in order for the join features task 706 to function, the workflow module 122 maps the input of the join features task 706 to the output of the transaction features task 702 to receive the transaction features (in the associated CSV file) and to the output of the inventory features task 704 to receive the inventory features (in the associated CSV file). The join features task 706 further includes, as functions, loading inventory and transaction feature sets, joining inventory and transaction feature sets on index columns, inserting missing records where possible, and saving the joined feature sets, for example in a comma-separated values (CSV) file. The join features task 706 further includes outputting a subsequent modified CSV file or a path to the subsequent modified CSV file.

In this example, the pipeline 700 next involves training of models 707, which includes the tasks of training an average price model 708 and training a unit forecast model 710.

In this example, in order for the average price model task 708 to function, the workflow module 122 maps the input of the average price model task 708 to the output of the join features task 706 (in the associated subsequent modified CSV file). The average price model task 708 further includes, as functions, loading the joined features dataset and extracting relevant information (such as columns), training a Random Forest Regression model, and saving average price model with metadata to data storage. The average price model task 708 further includes outputting a saving average price model file or a path to the saving average price model.

In this example, in order for the unit forecast model training task 710 to function, the workflow module 122 maps the input of the unit forecast model training task 710 to the output of the join features task 706 (in the associated subsequent modified CSV file). The unit forecast model training task 710 further includes, as functions, loading the joined features dataset and extracting relevant information (such as columns), training an Ensemble model, and saving the unit forecast model with associated metadata to data storage. The unit forecast model training task 708 further includes outputting a unit forecast model file or a path to the unit forecast model.

In this example, the pipeline 700 next involves forecasting using the trained models 711, which includes the tasks of generating scoring features 712 and generating a forecast 714.

In this example, in order for the generating scoring features task 712 to function, the workflow module 122 maps the input of the generating scoring features task 712 to the originating input 730 where it receives the input CSV file. The generating scoring features task 712 includes, as functions, extracting future inventory data from the database, transforming and extracting scoring features from the inventory data, and saving the scoring features set, for example in a comma-separated values (CSV) file. The scoring features task 704 further includes outputting a scoring features CSV file or a path to the scoring features CSV file.

In this example, in order for the generating a forecast task 714 to function, the workflow module 122 maps the input of the generating a forecast task 714 to the output of the average price model task 708 (in the saving average price model file), the output of the unit forecast model training task 710 (in the unit forecast model file), and the output of the generating scoring features task 712 (in the scoring features CSV file). The generating a forecast task 714 includes, as functions, loading the scoring features set, loading the average price model, loading the unit forecast model, applying the models to the scoring features dataset, generating a forecast, and saving the forecast, for example in a comma-separated values (CSV) file. The generating a forecast task 714 further includes outputting the forecast in a forecast CSV file or a path to the forecast CSV file.

In this example, the pipeline 700 next involves delivery and/or reporting 715, which includes the tasks of report generation 716 and forecast delivery 718. In this example, in order for the report generation task 716 to function, the workflow module 122 maps the input of the report generation task 716 to the output of the generating a forecast task 714 (in the forecast CSV file). The report generation task 716 further includes, as functions, loading the forecast data, generating an anomaly report, generating a correlation report, and saving the anomaly report and the correlation report to data storage. The scoring features task 704 further includes outputting an anomaly report and/or a correlation report to the culminating output 740, which it is mapped to by the workflow module 122; for example, because no other tasks in the pipeline are dependent on the output of the report generation task 716.

In this example, in order for the forecast delivery task 718 to function, the workflow module 122 maps the input of the forecast delivery task 718 to the output of the generating a forecast task 714 (in the forecast CSV file). The forecast delivery task 718 further includes, as functions, loading the forecast file, connecting to a file hosting service or protocol, uploading the forecast file to the file hosting service or server, and saving a success flag file to data storage. The forecast delivery task 718 further includes outputting a success flag file or a path to the success flag file to the culminating output 740, which it is mapped to by the workflow module 122; for example, because no other tasks in the pipeline are dependent on the output of the forecast delivery task 718.

Advantageously, the embodiments described herein, as exemplified above, allow for the ability to amend the pipeline easily and efficiently, without having to change hard-coded dependencies of the tasks, which is an example of a characteristic problem in the art. In this way, the task definitions are containerized for redeployment in any pipeline because the tasks are decoupled from having to define dependencies. This can substantially speed up development by providing flexible configuration of the pipeline, and can greatly improve a research process where experimentation, or machine learning model fine tuning, is desired for different aspects of the pipeline. Additionally, this can allow the pipeline to be highly customizable; for example, for use with different subjects and data sets.

Advantageously, in the embodiments described herein, individual tasks can be changed, or substituted for, with having to redefine one or more other tasks, which allows for easy reuse of the pipeline, easy scalability of the pipeline, substantial time savings in development, and computational savings for not have to regenerate the whole pipeline. Advantageously, the embodiments described herein also provide some guard against breakage of the system, and allow an administrator or developer with less experience to make changes, due to not having to redefine the actual tasks in the pipeline, but rather only require the adjustment of the workflow.

Thus, the embodiments described herein provide a technological solution to the characteristic technical problems in the art due to pipeline inflexibility. The embodiments described herein can provide a containerized and flexible solution that can be rapidly deployable on various platforms and may be fault tolerant. The embodiments described herein can also allow for intelligent load balancing through using machine learning in various pipeline configurations. The embodiments described herein can also be pluggable for independently scalable computation resources (such as via spark/tensor flow).

In a particular embodiment, the workflow generated by the workflow module 122 can allow for multiple Implementations of the pipeline for use through subclassing and/or overriding workflow or task definitions.

In further embodiments, the pipeline, having a respective workflow and generated as described herein, can be a portion of a larger pipeline or can be serialized, nested, or otherwise combined with other pipelines each having their own respective workflow. As such, the workflow of a specific pipeline can be part of a response flow of a bigger workflow, allowing for even greater flexibility for the implementation of an overall system. In an example, two workflows can be combined by mapping the originating input of one workflow to the culminating output of another workflow.

Although the invention has been described with reference to certain specific embodiments, various modifications thereof will be apparent to those skilled in the art without departing from the spirit and scope of the invention as outlined in the claims appended hereto. The entire disclosures of all references recited above are incorporated herein by reference.

1. A method for flexible pipeline generation, the method executed on at least one processing unit, the method comprising:
generating two or more tasks, the two or more tasks defining at least a portion of the pipeline;
for each task, receiving a functionality for the respective task and receiving at least one input and at least one output associated with the respective task;
generating a workflow for defining associations for the two or more tasks, the workflow having an originating input and a culminating output, the generating of the workflow comprising:
mapping the output of at least one of the tasks with the culminating output;
mapping the input of at least one of the tasks with the output of at least one of the other tasks, wherein for each task having an unmapped input, determining which outputs of other tasks are depended on to be received as input for the functionality of the respective task; and
mapping the input of at least one of the tasks with the originating input; and
executing the pipeline using the workflow for order of execution of the two or more tasks.

2. (canceled)

3. The method of claim 1, wherein the mapping of the input of at least one of the tasks with the output of at least one of the other tasks comprising, for each task having an unmapped output, determining which inputs of other tasks are depended on to be provided as output for the functionality of such other task.

4. The method of claim 1, wherein the mapping of the input of at least one of the tasks with the output of at least one of the other tasks comprising:
mapping the output of at least one of the tasks with the input of the at least one tasks mapped to the culminating output where such input is depended on for the functionality of the respective task; and
iteratively determining whether inputs of any tasks having mapped outputs depend on an output of an other task for the functionality of such task, and where there is such a dependency, mapping the input of the respective task to the output of the other task to which the respective task depends, otherwise for the at least one tasks with an unmapped input, performing the mapping of the input of the at least one tasks with the originating input.

5. The method of claim 1, wherein the mapping of the input of at least one of the tasks with the output of at least one of the other tasks comprising:
mapping the input of at least one of the tasks with the output of the at least one tasks mapped to the originating input where such output is depended on as input for the functionality of the respective task; and
iteratively determining whether outputs of any tasks having mapped inputs are depended on to be provided as input of an other task for the functionality of such other task, and where there is such a dependency, mapping the output of the respective task to the input of the other task to which the respective task depends, otherwise for the at least one tasks with an unmapped output, performing the mapping of the output of the at least one tasks with the culminating output.

6. The method of claim 1, wherein the mapping of the output of at least one of the tasks with the culminating output comprising determining whether outputs of at least one of the tasks are not depended on as input to at least one of the other tasks and mapping the outputs of such tasks to the culminating output.

7. The method of claim 1, wherein the mapping of the input of at least one of the tasks with the originating input comprising determining whether inputs of at least one of the tasks are not dependent on outputs of any other tasks and mapping the inputs of such tasks to the originating input.

8. The method of claim 1, wherein the mapping of the output of at least one of the tasks with the culminating output comprising mapping the output of at least one of the tasks to the culminating output where such tasks comprise an output signifier.

9. The method of claim 1, wherein the mapping of the input of at least one of the tasks with the originating input comprising mapping the input of at least one of the tasks to the originating input where such tasks comprise an input signifier.

10. The method of claim 1, further comprising:
receiving modification, the modification comprising at least one of: a modified functionality for at least one of the tasks, a modified input for at least one of the tasks, a modified output for at least one of the tasks, a removal of at least one of the tasks, and an addition of a new task comprising a functionality, an input, and an output;
reconfiguring the workflow comprising the modification by redefining associations for the tasks, reconfiguring the workflow comprising:
mapping the output of at least one of the tasks with the culminating output;
mapping the input of at least one of the tasks with the output of at least one of the other tasks; and
mapping the input of at least one of the tasks with the originating input; and
executing the pipeline using the reconfigured workflow for order of execution of the tasks.

11. A system for flexible pipeline generation, the system comprising at least one processing unit and a data storage, the at least one processing unit in communication with the data storage and configured to execute:
a task module to generate two or more tasks, the two or more tasks defining at least a portion of the pipeline, for each task, the task module receives a functionality for the respective task and receives at least one input and at least one output associated with the respective task;
a workflow module to generate a workflow for defining associations for the two or more tasks, the workflow having an originating input and a culminating output, the generating of the workflow comprising:
mapping the output of at least one of the tasks with the culminating output;
mapping the input of at least one of the tasks with the output of at least one of the other tasks, wherein for each task having an unmapped input, determining which outputs of other tasks are depended on to be received as input for the functionality of the respective task; and
mapping the input of at least one of the tasks with the originating input; and
an execution module to execute the pipeline using the workflow for order of execution of the two or more tasks.

12. (canceled)

13. The system of claim 11, wherein the mapping of the input of at least one of the tasks with the output of at least one of the other tasks comprising, for each task having an unmapped output, determining which inputs of other tasks are depended on to be provided as output for the functionality of such other task.

14. The system of claim 11, wherein the mapping of the input of at least one of the tasks with the output of at least one of the other tasks comprising:
mapping the output of at least one of the tasks with the input of the at least one tasks mapped to the culminating output where such input is depended on for the functionality of the respective task; and
iteratively determining whether inputs of any tasks having mapped outputs depend on an output of an other task for the functionality of such task, and where there is such a dependency, mapping the input of the respective task to the output of the other task to which the respective task depends, otherwise for the at least one tasks with an unmapped input, performing the mapping of the input of the at least one tasks with the originating input.

15. The system of claim 11, wherein the mapping of the input of at least one of the tasks with the output of at least one of the other tasks comprising:
mapping the input of at least one of the tasks with the output of the at least one tasks mapped to the originating input where such output is depended on as input for the functionality of the respective task; and
iteratively determining whether outputs of any tasks having mapped inputs are depended on to be provided as input of an other task for the functionality of such other task, and where there is such a dependency, mapping the output of the respective task to the input of the other task to which the respective task depends, otherwise for the at least one tasks with an unmapped output, performing the mapping of the output of the at least one tasks with the culminating output.

16. The system of claim 11, wherein the mapping of the output of at least one of the tasks with the culminating output comprising determining whether outputs of at least one of the tasks are not depended on as input to at least one of the other tasks and mapping the outputs of such tasks to the culminating output.

17. The system of claim 11, wherein the mapping of the input of at least one of the tasks with the originating input comprising determining whether inputs of at least one of the tasks are not dependent on outputs of any other tasks and mapping the inputs of such tasks to the originating input.

18. The system of claim 11, wherein the mapping of the output of at least one of the tasks with the culminating output comprising mapping the output of at least one of the tasks to the culminating output where such tasks comprise an output signifier.

19. The system of claim 11, wherein the mapping of the input of at least one of the tasks with the originating input comprising mapping the input of at least one of the tasks to the originating input where such tasks comprise an input signifier.

20. The system of claim 11, wherein:
the task module further receives modification, the modification comprising at least one of: a modified functionality for at least one of the tasks, a modified input for at least one of the tasks, a modified output for at least one of the tasks, a removal of at least one of the tasks, and an addition of a new task comprising a functionality, an input, and an output;
the workflow module reconfigures the workflow comprising the modification by redefining associations for the tasks, reconfiguring the workflow comprising:
mapping the output of at least one of the tasks with the culminating output;
mapping the input of at least one of the tasks with the output of at least one of the other tasks; and
mapping the input of at least one of the tasks with the originating input; and
the execution module further executes the pipeline using the reconfigured workflow for order of execution of the tasks.
